(19) United States
(12) Patent Application Publication
(10) Pub. No.: US 2026/0266397 A1
(43) Pub. Date: Sep. 10, 2026

(54) HIGH PRESSURE MICROFLUIDIC VALVE

(71) Applicant: LabSmith, Inc., Livermore, CA (US)

(72) Inventors: Kirsten Pace, Livermore, CA (US); Eric Cummings, Livermore, CA (US); Gary Garza, Livermore, CA (US)

(73) Assignee: LabSmith, Inc., Livermore, CA (US)

(21) Appl. No.: 19/559,817

(22) Filed: Mar. 6, 2026

Related U.S. Application Data
(60) Provisional application No. 63/769,142, filed on Mar. 9, 2025.

(51) Int. Cl. F16K 99/00

(52) U.S. Cl. CPC F16K 99/0013; F16K 99/0028; F16K 99/0034

(57) ABSTRACT

Microfluidic valves that may be used for high pressure applications.

### CROSS-REFERENCES TO RELATED APPLICATIONS

This application claims priority to U.S. Provisional Application No. 63/769,142, filed Mar. 9, 2025, the entire contents of which are incorporated herein by reference for all purposes.

### BACKGROUND

Conventional high-pressure microfluidic switching valves have large internal volumes, are heavy and big, and require significant power to switch, making them unsuitable for many high-pressure applications that require a compact design, such as space applications and portable diagnostic and analytical instruments.

### SUMMARY

Some embodiments described herein solve these problems with novel miniature high-pressure switching valve designs that facilitate a high-compression load to provide high-pressure capability by nesting a compliant, inert valve body and rotor inside rigid housings.

### BRIEF DESCRIPTION OF THE DRAWINGS

FIG. 1A shows a view 1000 split along the centerline of the interior of a switching valve in accordance with some embodiments.

FIG. 1B shows a view 1200 split along the centerline at 45° in accordance with some embodiments.

FIG. 1C shows a top offset exploded view of an embodiment with the actuator removed in accordance with some embodiments.

FIG. 1D shows a bottom offset exploded view of a valve embodiment the actuator removed in accordance with some embodiments.

FIG. 2A shows an offset view of the valve rotated to the extreme clockwise “A” position in accordance with some embodiments.

FIG. 2B shows a sectioned view of the valve interior in the “A” position in accordance with some embodiments.

FIG. 2C shows an offset view of the valve in the “closed” position ~45° in accordance with some embodiments.

FIG. 2D shows a sectioned view the valve in the closed position in accordance with some embodiments.

FIG. 2E shows an offset view of the valve in the “B” position in accordance with some embodiments.

FIG. 2F shows a sectioned view of the valve in position “B” in accordance with some embodiments.

FIG. 3A shows an exploded view of the stem and rotor in accordance with some embodiments.

FIG. 3B shows a top view of the mating shape 3102 on the rotor in accordance with some embodiments.

FIG. 3C shows an exploded view of a stem and rotor having an alternative mating shape in accordance with some embodiments.

FIG. 3D shows a top view of this alterative rotor in accordance with some embodiments.

FIG. 3E shows an exploded view of another stem and rotor in accordance with some embodiments.

FIG. 3F shows a rotor top view of this other alternative rotor in accordance with some embodiments.

FIG. 3G shows an exploded view of another stem and rotor in accordance with some embodiments.

FIG. 3H shows a rotor top view of this other alternative rotor in accordance with some embodiments.

FIG. 4A shows a view of a 6-port valve in an open position in accordance with some embodiments.

FIG. 4B shows a view of a 6-port valve rotated by ~180°/6 in accordance with some embodiments.

FIG. 4C shows a view of a 3-port proportional valve wherein the relative flow between two ports is adjustable via the use of a double-tapered channel in accordance with some embodiments.

FIG. 4D shows a view of a 4-port switching valve in which the rotor comprises a straight channel in accordance with some embodiments.

FIG. 5A shows an exterior view of a housed ratcheting valve embodiment in accordance with some embodiments.

FIG. 5B shows a sectioned view along the midplane of the ratcheting valve in accordance with some embodiments.

FIG. 5C is an offset view of an alternative ratcheting valve embodiment in accordance with some embodiments.

FIG. 5D shows a top view of the valve in FIG. 5C in accordance with some embodiments.

FIG. 5E shows a view at the channel mid-plane inside the valves in FIGS. 5A and 5B in accordance with some embodiments.

FIG. 5F shows a view at the channel mid-plane inside the valve in FIG. 5C in accordance with some embodiments.

FIG. 6A shows an exploded bottom angle view of the parts involved in a removable valve body in accordance with some embodiments.

FIG. 6B shows a bottom-angle view of the assembled valve body in accordance with some embodiments.

FIG. 6C shows a front view of the assembled valve body in accordance with some embodiments.

FIG. 7A shows a view of a valve embodiment fitted with a threaded “swage-type” one-piece fitting in accordance with some embodiments.

FIG. 7B shows a cut-away view of fittings along the mid-plane of the valve ports in accordance with some embodiments.

FIG. 7C shows a cut-away plan view of fittings along the mid plane of the ports in accordance with some embodiments.

FIG. 8A show a view of a rotor comprising a relatively an embedded seal material in accordance with some embodiments.

FIG. 8B shows an assembly having an alternative inclusion geometry in accordance with some embodiments.

FIG. 8C shows an assembly having a circumferential channel in an inclusion in accordance with some embodiments.

FIG. 8D shows an assembly having a channel arrangement that can hold extra volume in accordance with some embodiments.

FIG. 8E shows an alternative rotor comprising a surface coating of the sealing material in accordance with some embodiments.

FIG. 8F shows an alternative inclusion geometry in which a compliant sealing material is sandwiched in the rotor in accordance with some embodiments.

FIG. 8G shows an alternative geometry wherein a microfluidic circuit is sandwiched in the rotor in accordance with some embodiments.

FIG. 9A shows an exterior tilted view of an 8-port selector valve embodiment designed for mounting to a microfluidic manifold in accordance with some embodiments.

FIG. 9B shows an exploded view of the manifold-mountable 8-port selector valve in accordance with some embodiments.

FIG. 9C shows a top view of the wetted components and base of the manifold-mountable 8-port selector valve in accordance with some embodiments.

FIG. 9D shows a cut-away view of the flow path within a manifold-mountable 8-port selector valve in accordance with some embodiments.

FIG. 9E shows a cut-away view of the flow path within a manifold-mountable 8-port selector valve in accordance with some embodiments.

FIG. 10A shows an exterior tilted view of a 3-port valve embodiment designed for mounting to a microfluidic manifold in accordance with some embodiments.

FIG. 10B shows an exploded view of the manifold-mountable 3-port valve in accordance with some embodiments.

FIG. 10C shows a top view of the wetted components and base of the manifold-mountable 3-port valve in accordance with some embodiments.

FIG. 10D shows a cut-away view of the flow path within a manifold-mountable 3-port valve in accordance with some embodiments.

FIG. 10E shows a cut-away view of the flow path within a manifold-mountable 3-port valve in accordance with some embodiments.

FIG. 11 shows a cut-away view of the flow path within a manifold-mountable valve comprising a rotor with a circumferential channel in accordance with some embodiments.

### DETAILED DESCRIPTION

As used herein, a “microfluidic valve” is a valve that is designed to direct, throttle, stop, or release small volumes of fluids or gases to and from microfluidic apparatus. Some of the advantages that microfluidic apparatus may provide compared to similar macrofluidic apparatus may include better fluid, reaction, and thermal control, the ability to exploit phenomena that occur in microscopic geometries, and the use of minimal fluid volumes to limit usage of expensive reagents, to match fluid volumes with cell-scale volumes, etc. In order to minimize overall fluid volumes, valves with low internal volumes may be needed. The overall size of the valves may be important because larger sizes may impact the overall size of an instrument or application necessitating longer tubing between components (valves, pumps, sensors, etc.). Additionally, certain applications like space instruments or field instruments may require of low size, weight, and power use. It is therefore an objective of some embodiments to minimize the overall size of a microfluidic valve, while maintaining a large envelope of working pressures and temperatures.

As used herein “wetted” means exposed to fluids. Fluids considered in some embodiments include gases, liquids, solvents, reagents, particle suspensions, slurries, molecular suspensions, ionic liquids, aqueous solutions, multi-phase fluids, vacuum, supercritical fluids etc.

The wetted components of a valve according to some embodiments are a “body,” herein, comprising a plurality of ports that connect to tubing or other external components, and a “rotor,” herein, that rotates to allow selected ports to be in breakable fluidic communication via at least one fluid channel within the rotor. In some embodiments, actuation of the rotor can be accomplished directly or via one or more linkages by one or more of: manual control, a motor, a stepper motor, a brushless motor, a DC motor, a gearmotor, a solenoid, another actuator as known in the art. Some embodiments of actuators may further comprise a means of position sensing, such as an optical encoder, potentiometer, angle sensor, accelerometer, etc., as known in the art, and some embodiments may further utilize the position sensing information in a motion-control feedback loop as known in the art.

A feature of some embodiments is precision alignment between the rotor and the valve body. The head of the valve rotor includes the fluid channel(s) that connects the valve outlet ports together. The channels on the rotor may include one or more slots or holes that allow fluid to pass through the rotor. These rotor channels may need to align precisely with ports in the valve body to allow reliable flow between two (or more) ports when the valve is in a position herein called an “open” position. A position in which the rotor port aligns with zero valve-body ports is herein called a “closed” position. In some embodiments, a channel may align with only one port, herein called a “terminal” position. In order to minimize the liquid volume of the valve, some embodiments may limit the fluid conduit diameters in the valve stem head and ports to less than 2 mm and in some embodiments, in the range 0.050 to 1 mm diameter, requiring high machining precision, alignment, and stability under massive compression loads.

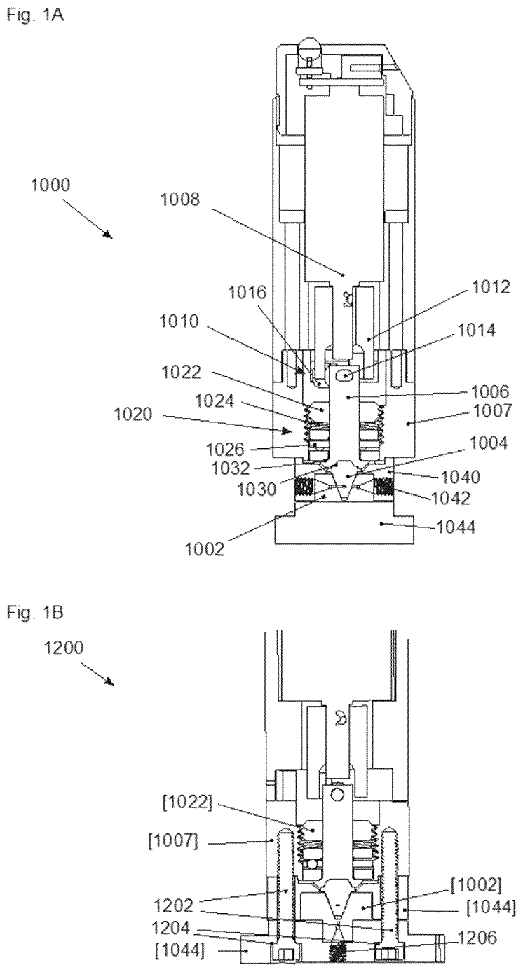

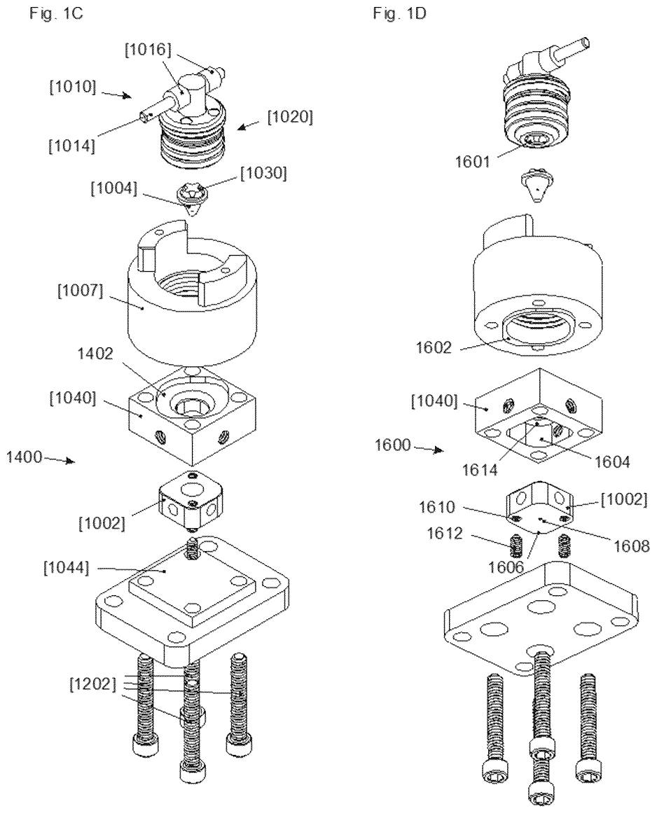

FIG. 1A shows a view 1000 split along the centerline of the interior of a switching valve. Element 1002 is the valve body, element 1004 is the valve rotor. In this embodiment the valve rotor connects via a rigid rotating stem 1006 and linkage body 1007 to a rotary actuator, e.g., the gear motor 1008, via an escapement mechanism 1010 comprising a fork 1012 and a cross-piece 1014 attached to the stem, e.g., via pressing. Some embodiments of escapements may further comprise at least one compliant bearing structure 1016 between two rigid escapement members. In some embodiments, this compliant bearing structure may protect the actuator 1008 from internal damage from shock loads.

Element 1020 is a mechanical means of applying a preload force to the valve rotor (1004) directly or via a valve stem (1006). Element 1020 may comprise one or more of: a threaded ring (1022), a washer (1024), a thrust bearing (1026) that generates a preload force via a mechanical mechanism, e.g., engagement of threads in (1022) and (1007), then transfers this preload force to a proximal surface of the rotor (1004) or to a proximal surface 1030 of the stem and then to a proximal surface 1032 of the rotor. In some embodiments washer (1024) may comprise a mechanical spring, such as a Belleville washer as known in the art.

Element 1040 is a rigid body shell that may mechanically support the body against expansive strain under pressure loads. Element 1040 may further comprise at least one mechanical fastening element to accommodate an interface to external apparatus or tubing herein called a “pressure interface,” e.g., the threads at 1042. Some embodiments may comprise one or more of: a thread (1042), an o-ring grove, a broken thread, a bayonet connection, a Luer-lock connector, a mechanically locking connector, a glue-on connector, an ultrasonically weldable connector, a threaded hole that it not concentric with a port.

Some embodiments may further comprise a mounting structure 1044, as known in the art. In some embodiments this mounting structure may be combined with element 1040. In some embodiments, this mounting structure is removable, e.g., via mechanical fasteners to provide physical access to the bottom surface of the valve body.

FIG. 1B shows a view 1200 split along the centerline at 45° with respect to the view 1000, showing a mechanical means of resolving the internal preload force imposed by 1020, e.g., via threads in 1007, bolts 1202, and bolt bearing surfaces 1204. In some embodiments, threaded connections may be arranged differently, as known in the art, e.g., circumferentially between surfaces of 1007 and 1022. Some other embodiments may comprise a locking feature such as a broken thread, a tongue-and-groove, a bayonet mount, etc. as known in the art. In some such embodiments, tightening 1022 may preload and lock elements a mating feature together.

In some embodiments, bolts 1202 may be removed to allow cleaning, servicing, or replacing of wetted components, application of a grease, etc.

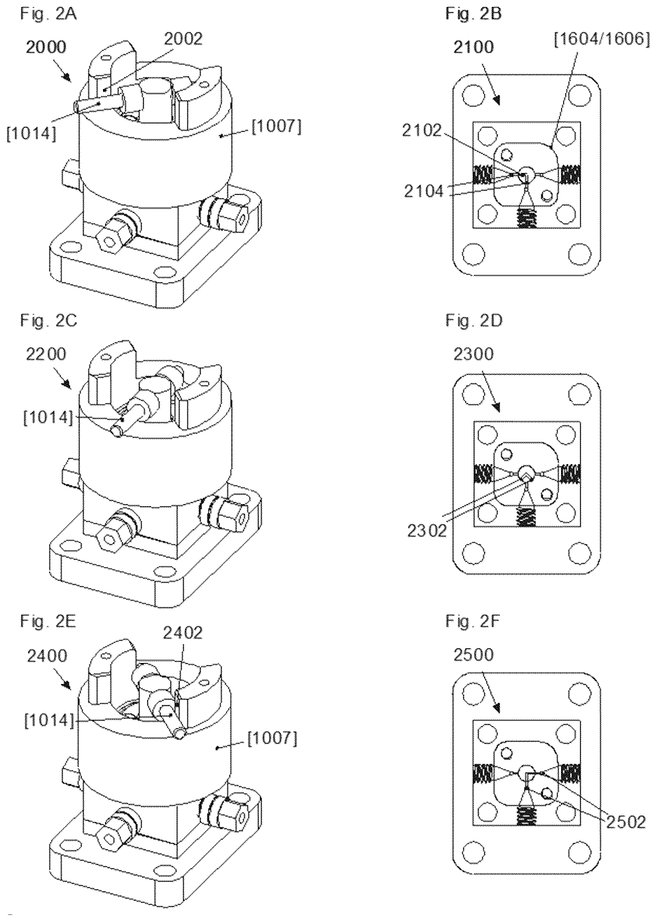

The embodiment shown in FIG. 2B has a provision for a downward pointing port 1206. To accommodate this port the valve body (1002) and mounting base (1044) may be modified connect to external apparatus, e.g., via a pressure interface such as an o-ring or interface fitting as illustrated.

FIG. 1C shows a top offset exploded view 1400 of an embodiment with the actuator removed. The escapement assembly (1010) and preload assembly (1020) are shown separated from the rotor (1004). This view shows the crosspiece (1014) and buffer structures (1016) clearly. In some alternative embodiments, this interface could be a spline, keyed, shaft, or other breakable interface as known in the art. One advantage of the arrangement shown may be that the cross-piece may act as an indicator or manual actuator.

The top (bearing) surface of the rotor (1030) contains keying features that transfer turning torque from the stem and force to and from the preload assembly (1020).

Element 1402 comprises an alignment and keying feature to stabilize the relative position of (1040) and (1007).

FIG. 1D shows a bottom offset exploded view 1600 of an embodiment with the actuator removed. Element 1601 are the mating features to surface (1030). Element 1602 is the mating key to (1402).

View 1600 shows the bottom sides of (1040) and valve body (1002). Some embodiments comprise a pair of keying surfaces, 1604 and 1606, that ensure that the valve body is inserted in the proper orientation. Some embodiments of valve bodies comprise a hole 1608. In some embodiments this hole is used to do one or more of: equalize pressure in the cavity between the valve rotor and body, provide a weep indication as known in the art, provide a grease or lubrication port, provide an opening for a bottom facing microfluidic port.

Some embodiments of valve bodies further comprise a threaded hole, e.g., 1610 such that a set screw 1612 may be used to drive the valve body out of a tight or press fit inside 1604 by pressing against the surface 1614. In some embodiments, the set screws may remain in place during operation to reduce valve body strains during high-pressure use. Some embodiments utilize an alternative mechanical extraction element, such as a ledge, alternative set screw arrangement, etc.

FIG. 2 shows how the internal rotor and valve body features line up in different valve positions according to an embodiment of a switching valve in accordance with some embodiments. The valve embodiment shown has 3 ports that connect to external tubing or components, a center port and two side ports and the actuator is not shown.

FIG. 2A shows an offset view 2000 of the valve rotated to the extreme clockwise position, herein called position “A.” wherein the surface of crosspiece (1014) touches the surface 2002 of (1007). FIG. 2B shows a sectioned view 2100 in this position of the interior of the valve along the centerlines of the fluid conduits. The valve rotor (1002) has an “L” shaped channel 2102 in this plane, comprising two substantially straight channels that intersect at 90°. In position A, the rotor channel openings align 2104 with the bottom and left port of the valve.

Some other L channels embodiments may intersect at an angle between 10° and 170° such that the two channels align simultaneously with two ports disposed at that angle. Some valve-rotor embodiments further comprise one or more additional intersecting channels disposed in the plane normal to the axis of rotation and coincident with at least one port, herein called the rotation plane or along or parallel to the axis of rotation. Some embodiments of valve rotors comprise a plurality of intersecting channels that are disposed at an angle relative to the rotation plane. In some embodiments this angle is chosen to improve alignment with one or more ports that are not disposed in the rotation plane.

This view shows the mated orientation keying features (1604) and (1606).

FIG. 2C shows an offset view 2200 of the valve rotated counter clockwise away from position A by ~45°. FIG. 2D shows a sectioned view 2300 of the valve in this position, herein called position “closed.” In this position of the rotor ports (2302), there is no overlap of the rotor and body ports so all ports are isolated from each other.

FIG. 2E shows an offset view 2400 of the valve rotated to the extreme counter clockwise position, herein called position “B,” wherein the crosspiece (1014) touches the surface 2402 of (1007). FIG. 2F shows a sectioned view 2500 of the fluid path plane. In position B the ports of the rotor and valve body line up 2502 to connect the bottom and right channels. As used herein this valve is a “3-port valve.”

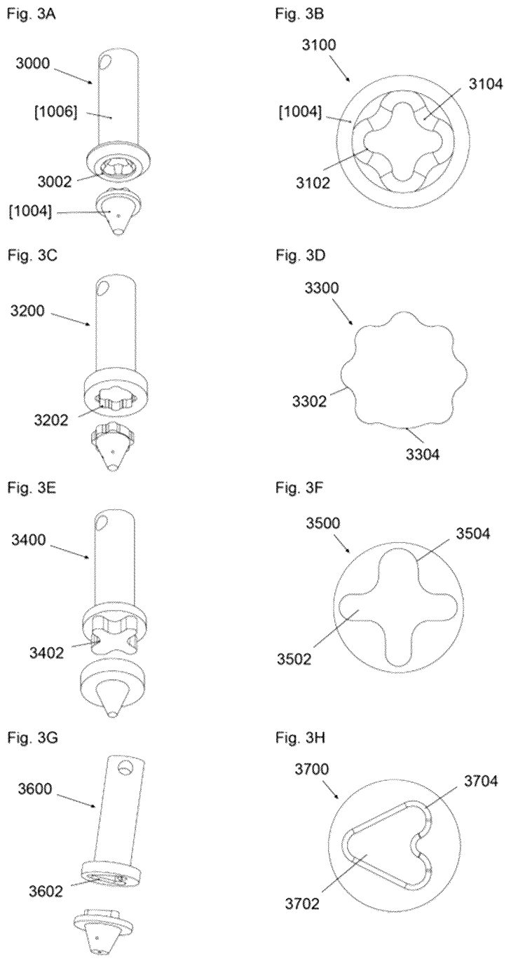

FIG. 3 shows views of rotor/stem mating geometries. Desirable features for mating geometries may include a relatively large contact area for force transfer, relatively large torque-transferring features to prevent damage or fatigue from actuation torque, avoidance of stress concentrations, keying to ensure proper relative alignment, having a concave mating surface or structural lip on the rigid stem to constrain the rotor from distortion under pressure. The fit between the rotor shaft and head may be critical for maintaining precise position accuracy of the stem under preload and at all actuation positions.

FIG. 3A shows an exploded view 3000 of the stem (1006) and rotor (1004) having a concave mating structure 3002 in the stem. FIG. 3B shows a top view 3100 of the mating shape 3102 on the rotor. In this embodiment, the mating shape is drafted (3104). Draft angles may range from 0 (no draft) to ~80° and preferably between 5° and 60°. In this embodiment, the rotor head has a male 4-pedal design with a ~10 deg tapered wall to facilitate insertion and removal of the head into the matching feature on the rotor shaft.

FIG. 3C shows an exploded view 3200 of a stem and rotor having a patterned structural lip 3202 that captures the rotor. FIG. 3D show a top view 3300 of this rotor. In this embodiment, the rotor shape has undulations 3302 similar to a Torx bit. This embodiment further comprises a break in rotational symmetry 3304 that can key the assembly against improper alignment.

FIG. 3E shows an exploded view 3400 of another stem and rotor embodiment. In this embodiment, the stem contains a protrusion 3402. FIG. 3F shows a rotor top view 3500. In this embodiment, the cavity 3502 has a keying feature 3504.

FIG. 3G shows an exploded view 3600 of another stem and rotor embodiment. In this embodiment, the stem contains a concave mating structure 3602. FIG. 3H shows a rotor top view 3700. In this embodiment, the protrusion 3702 has a relatively larger surface area and a prominent keying feature 3704. Other embodiments may comprise mating surfaces like or copied from standard screws and bolts, e.g., Philips, flat head, square head, Torx, three-prong Philips, Allen head, and derived designs, in either arrangement of concavity of the stem or rotor. Having this disclosed the design aims and these embodiments, it will be obvious to one skilled in the art to select suitable alternative embodiments.

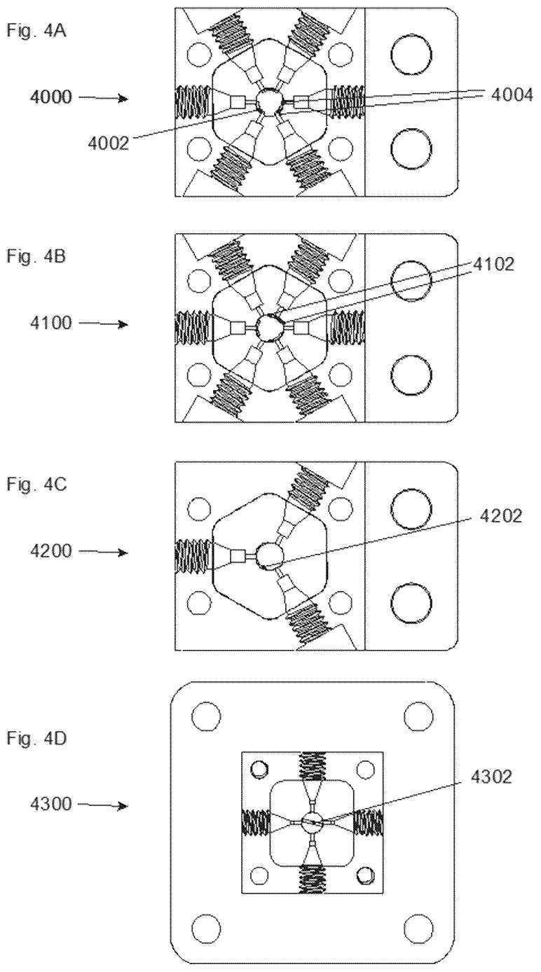

FIG. 4 shows fluidic-plane views of alternative valves according to some embodiments. Some embodiments of valves in FIG. 4 may further comprise actuation angle limits e.g., 2002, and 2402. Some embodiments of valves in FIG. 4 may be free to rotate or periodically lightly impeded from rotating in one direction and constrained against complete rotation in the other direction via a ratchet mechanism. Some embodiments of valves in FIG. 4 may be free to rotate in both directions.

FIG. 4A shows a view 4000 of a 6-port valve having three port pairs simultaneously in an open position in which adjacent ports are connected via a rotor channel. The rotor channel in this embodiment 4002 lies along the outer rotor surface. A second open position exists in which the rotor is rotated 60°, such that the rotor channels link an alternative set of port pairs in the valve body.

Some alternate embodiments of the valve in FIG. 4A may comprise any number of ports n greater than 1 and preferably between 3 and 10, such that the actuation rotation between ports is 360/n.

FIG. 4B shows a view 4100 of a 6-port valve having a rotor rotation of ~180°/n from the position shown in FIG. 4A.

This arrangement disconnects all ports from each other. Three ports are in the closed position and three ports are in the terminal position so rotor channel termini 4102 do not span two external ports.

FIG. 4C shows a view 4200 of a 3-port proportional valve wherein the relative flow between two ports is adjustable via the use of a double-tapered channel along the outside rotor surface. Some other embodiments of such a valve may utilize a serpentine flow path to provide a greater pressure drop or more resolution. Some other embodiments may utilize a porous coating, filling or bulk material to effect a variable pressure drop.

FIG. 4D shows a view 4300 of a 4-port switching valve in which the rotor comprises a straight channel 4302.

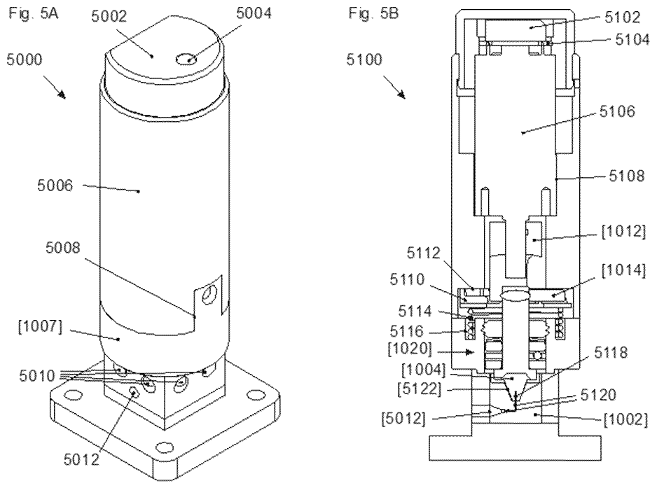

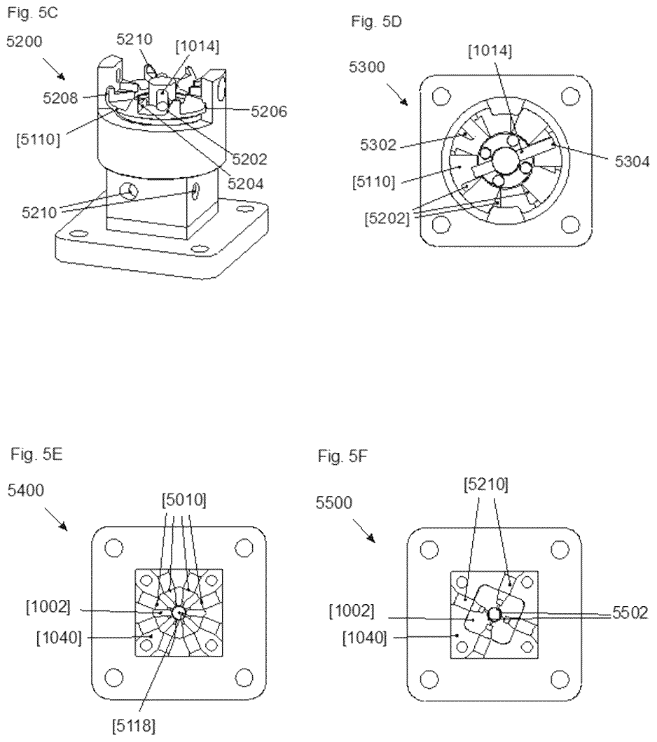

FIG. 5 shows embodiments of valves comprising a ratchet mechanism for rotational alignment and position sensing.

FIG. 5A shows an exterior view 5000 of a such a housed valve embodiment. Element 5002 is a valve cap that can be removed to service or replace the motor or to make adjustments to the valve preload. Element 5004 is an actuation indicator LED. Element 5006 is an actuator housing. Element 5008 is a contact surface between 5006 and 1007 that prevents relative rotation under actuation torque. In this embodiment, elements 5010 are a plurality of ports disposed radially around the valve. In this embodiment there are 8. Element 5012 is a port having a channel that always aligns with a channel in the rotor, thus this valve may function as a selector valve that connects port 5012 with any of the ports 5010. Such a selection operation requires accurate alignment of channel openings in the valve body and rotor.

FIG. 5B shows a sectioned view along the midplane of the valve that includes the center of port 5012. Element 5102 is an electrical connector for controlling valve actuation. Element 5104 is a printed circuit board that may comprise one or more of a connector, a slot or hole for motor terminals, a capacitor, a ferrite, a resistor, an electromagnetic interference filter, a serial EEPROM, a diode, a light-emitting diode, a thermistor, a rotary encoder, an optical sensor, a potentiometer, an accelerometer, a microcontroller.

Element 5106 is an actuator motor, such as a DC gearmotor. Element 5108 is a surface contact between housing 5006 and motor 5106 to constrain the motor against relative rotation under torsional loading. Element 5110 is a ratchet ring having a radial pattern of circumferential ramps and steps to produce a ratchet effect as the crosspiece 1014 rotates over the ramps and backs into the steps. Surface 5112 of 5006 is a ratchet stop against which the ratchet ring is pressed by a weakly preloaded spring 5114 that is captured in a circumferential pocket 5116.

In this “selector valve” embodiment, element 5118 is a part of a channel through the rotor (1004) along its axis of rotation. Element 5120 is an L-shaped channel in the valve body (1002) with one leg along the rotation axis of the rotor and the second leg leading to port (5012).

FIG. 5C is an offset view 5200 of a valve embodiment comprising the same ratchet mechanism as in FIG. 5B. In this view one can see a pattern of ramps 5202 and steps 5204. Elements 5206 and 5028 are, respectively, surface contacts that prevent gross rotation of the ratchet ring (5110) when the cross piece 1014 rotates across and into a ramped surface 5202, moving in the forward direction and into a step surface 5204 in the reverse direction. With this mechanism, the cross piece can rotate in the forward direction with a modulated resistance pressure produced by the need to push the ramp down against the spring (5114) force. In the backwards direction, the cross piece interferes with the step, which then forces the motion to stop at a point where the crosspiece contacts a surface 5204 to drive the surfaces into contact at 5208, halting backwards motion at a repeatable angular position. The design of the rotor and valve body is such that at each such stop, the roto channel opening is aligned with a valve body opening. The protrusion 5210 are designed to seat on the surface 5112 to limit motion of the ratchet ring under the spring force.

The valve embodiment shown in 5C comprises 4 ports 5210. FIG. 5F shows the internal channel arrangement in this embodiment.

FIG. 5D shows a top view 5300 of the valve in FIG. 5C. The pattern of ramps (5202) around the ratchet ring 5100 can be seen more clearly than in FIG. C. Furthermore, there is an additional ramp 5302 that extends inward less than the regular ramps and disposed approximately evenly between two regular ramps. This view also shows an asymmetrical offset in the crosspiece such that it protrudes further on one side, 5304. With this asymmetry, only the 5304 end of the crosspiece engages with ramp 5302 when it rotates past it. The effort to drive past each ramp may be exposed by a momentary rise in the current driving the actuator as it drives the ratchet ring into the spring. Ramp 5302 produces an extra ramp load that occurs once per rotation. In concert with the other drive current pulses, this extra index pulse provides a positive position sense without need for a separate means of measuring shaft or motor motion.

FIG. 5E shows a view 5400 at the mid-plane of the radial fluid channel inside the valve shown in FIGS. 5A and 5B. The radial leg of the L-shaped channel in the rotor is visible in this view.

FIG. 5F shows a view 5500 at the channel mid-plane inside the valve shown in FIG. 5C. This valve comprises a pair of circumferential channels 5502 that progressively connect pairs of port in one rotational direction. Such a valve may be useful for efficiently automating a pipe-lined, multiple step microfluidic process. Some alternative embodiments of this progressive valve may comprise additional ports or a different number of circumferential channels.

FIG. 5 shows an embodiment of a selector valve where there is a common port that is always open, and the rotor turn to connect a channel a port, herein called the “selected port”. FIG. 5 depicts an embodiment with 8 “selector” ports, but the number of selector ports can be any number, preferably between 2 and 32. The common port passes through the bottom of the valve, e.g., 1206, in some embodiments of selector valves.

A valve according to some embodiments achieves its high-pressure rating via a design that allows high compression loads between the rotor and body. This design is facilitated by a conical rotor (1004) and matching body shape (1002), as shown in FIG. 1. In some embodiments, the included angle of the conical is 35°-45°, as shown in FIG. 1, but other embodiments may use angles between 10°-70°.

In some embodiments the rotor (1004) and valve body (1002) are made from a high-performance plastic, such as Vespel, which creates a mechanically strong plastic-plastic sealing surface with a high resistance to wear while maintaining a relatively low stiction and friction contact and good chemical and solvent resistance. Having specified these desired traits and example material, it would be obvious to one of reasonable skill in the art to select an alternate polymer formulation or to formulate a composite polymer from which to construct a wetted object.

In some embodiments a lubricating grease is used on the sealing surface between the rotor and body to improve sealing and/or reduce friction during actuation. Some embodiments of valves may use a grease or oil comprising one or more of: a silicone, hydrocarbon, a biological material, a fluorinated or perfluorinated grease or oil, a suspension of Teflon particles.

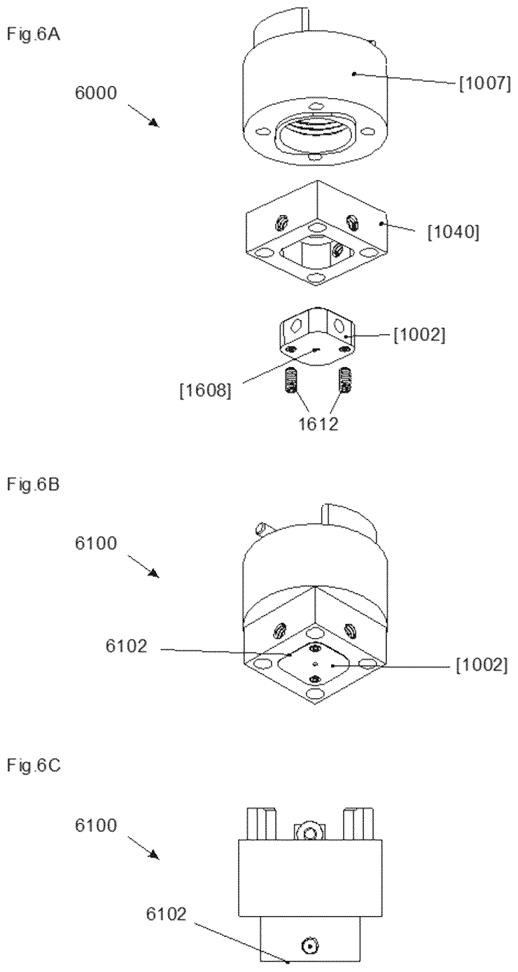

FIG. 6A shows an exploded bottom angle view 6000 of the parts involved in a removable valve body. FIG. 6B shows a bottom-angle view 6100 of the assembled valve body and FIG. 6B shows a front view 6200. The design may include an interference fit between the valve body (1002) and (1040). It may further include an over-thickness of 1002, e.g., 6102, such that the valve base (1044) applies a preload force to the bottom surface of 1002. By tightening the set screws 1612, the valve body may be driven from its cavity in 1040 for removal, replacement, inspection, cleaning, etc. The embodiment of the valve body in FIG. 6 comprises a hope (1608) disposed substantially at the rotational axis at the base of the wetted body (1002). This port may have multiple uses. It may provide a relief for excess lubricant to flow into during valve assembly and preloading. It may be used as a fill port to load additional lubricant into the cavity between the tip of the stem head and the base of the wetted body conical cavity. This cavity may be useful to allow full seating and preload of the valve rotor head along the conical walls of the wetted body to enhance high-pressure performance. It may ease the removal of the rotor from the valve body by equalizing pressure or allow force or pressure to be applied externally to force the rotor from its cavity in the valve body. In some embodiments having a relief port, the valve base (1044) may become a critical component in the valve sealing apparatus.

In some embodiments, the valve rotor and stem can be made out of a single material piece, or can be made out of two or more separate pieces, e.g., with a metal shaft (1004) and a high-performance plastic head (1006). The two-piece design may have the advantage reduced distortion of the rigid shaft under high or actuation torque. It may also facilitate partial disassembly of the valve so that the wetted components (valve head and wetted body) can be cleaned between uses (i.e. autoclaved). This feature may be important for valve re-use in some applications where elimination of cross-contamination is critical, e.g., in microbiology, clinical medicine, trace analysis, etc.

Some embodiments of valves may further comprise a thermal actuator, such as a Peltier element, resistive heater, or compressed fluid channel in thermal communication with a rotor. Some embodiments of thermal controllers may comprise one or more of: the rotor, valve body, stem, housing, mounting plate or valve exterior that is subject to pressurization and depressurization through at least one port in fluidic communication to a pump or storage vessel. In some embodiments, the pump may comprise a syringe pump, constant displacement pump or continuous flow pump, as known in the art. In some embodiments a phase-change fluid, such as a refrigerant, freon, hydrocarbon, etc., as known in the art, may fill the channel. In some embodiments, the channel may be alternately pressurized and depressurized to effect a change in the temperature of a channel in the rotor.

Some valve embodiments further comprise a temperature sensing element proximal to the rotor. Some embodiments further comprise closed-loop temperature control via feedback from a thermal sensor.

Some valve embodiments may support chemical reactions within a rotor channel. Some such reactions include PCR and other thermocyclic reactions as known in the art.

Some embodiments of a rotor channel may comprise a surface, porous bulk material, or gel, herein called a “packing” that collects a component from a fluid therein. Some embodiments of rotor channels may establish this “packing” during one or more of: material selection, fabrication, post-fabrication modification, during operation, a chemical reaction, a gelation, a crosslinking, a hydrolytic reaction, a reduction reaction, an oxidation reaction.

Some embodiments comprising a packing may further comprise a capacity to release an element into a fluid. In some embodiments this release is driven by one or more of chemical, thermal, conformation, biochemical, pH, ionic, electrochemical, phase changes.

Applications of a single-port valve may include temporary storage of a compressible fluid, for example, in which the valve is switched to an open or terminal position, then a pressure in a fluidically connected channel is changed, then the valve is switched to a closed position that traps a mass of fluid that may be subsequently transferred to an adjacent port or back to the same port.

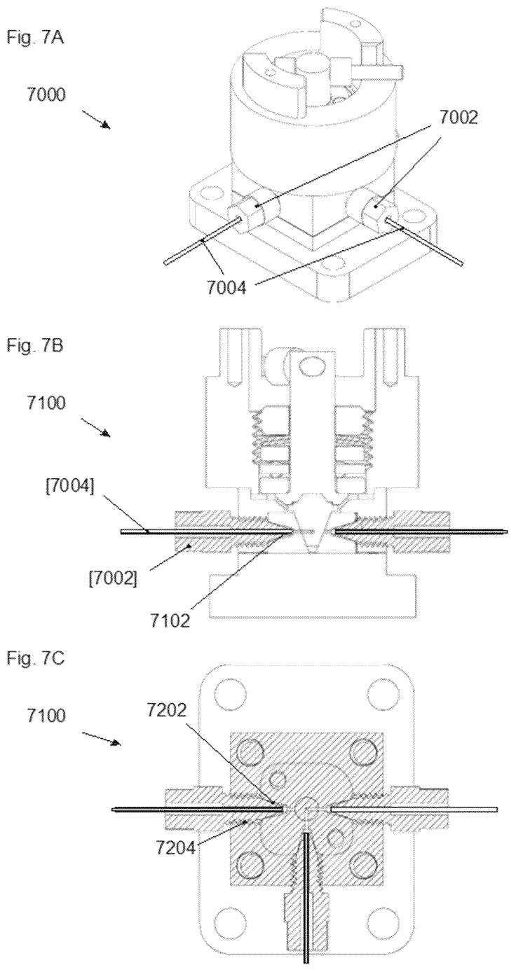

Another important feature of the selector or switching valves is the port connection to tubing or an external component. FIG. 7A shows a view 7000 of a valve embodiment according to some embodiments wherein each port is fitted with a threaded “swage-type” one-piece fitting 7002 that is manufactured from a compliant, inert material (such as PEEK). FIG. 7B shows a cut-away view 7100 along the mid-plane of the valve ports. FIG. 7C shows a cut-away plan view 7200 along the mid plane of the ports. In this embodiment, tubing 7004 is inserted in the fitting to a seating position 7102. The fitting is tightened using threads 7204 to achieve a high-pressure seal between fitting and port wall 7202. The compression from the taper at 7202 pinches the fitting around the tubing, producing friction and stiction to resist being pulled out or pushed out by internal pressure. With the tubing thus installed in the port, this design contains no channel volume that is not swept when the valve is opened, herein called “dead volume.” This fitting and port design does not substantially increase the overall size of the valve, allowing short tubing lengths between valves and other components.

In the embodiment of FIG. 7, the friction generated by the compression of the one-piece fitting onto the tubing outer diameter provides the force that holds the tubing in place under valve pressure.

Some alternative embodiments of fittings 7002 may comprise one or more of: a different compliant material, an additive, a filler, a composite, carbon black, carbon granules, rigid inclusions, a powder, to increase the friction coefficient between the fitting and tubing. In some embodiments a surface coating or modification may be applied during manufacturing or assembly to increase the holding force such as one or more of: an adhesive, a thread locker, a plasma treatment, and adhesion promotor, PEI, a solvent, a powder, granules, graphite. In some embodiments a mechanism of enhanced holding force may be mechanical interlocking via plastic flow around intentionally introduced asperities or granules between the surfaces.

In some embodiments, intentional surface roughness or striated features on the inner surface, such as a partial thread shape, thread cuts, ridges, etc. may help to produce local plasticity or mechanical interlocking between fitting and tubing to enhance holding strength.

In some embodiments, the threading and sealing materials used may comprise different materials, a graded material, a composite material, or another arrangement such that the threaded material has high strength to resist stripping and tool stresses while the sealing material has the compliance and flow needed to create a pressure seal and hold tubing in place.

An alternative embodiment uses an O-ring interface or gasket to connect the tubing or components to the valve.

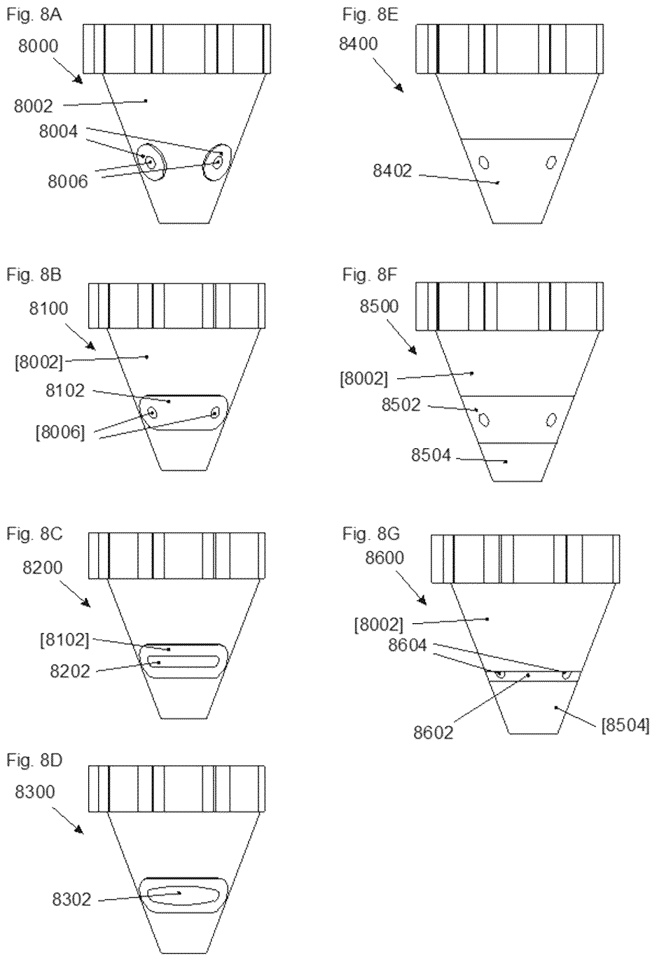

FIG. 8 shows exterior views of alternative rotor embodiments. FIG. 8A show a view 8000 of a rotor comprising a relatively rigid structure 8002 and an embedded seal material 8004. In some embodiments the seal material may be press fit, cross-linked in place, glued in place, molded in place, injection molded in place, or otherwise situated in at least one cavity internal to 8002. Elements 8006 are port openings that may be drilled, cast, molded, etc. Element 8002 is a rigid pressure-resistant structure herein called a “containment vessel” that constrains the comparatively compliant sealing surface. Some embodiments dispose additional structures to oppose the bearing forces generated on 8004. Some applications of a rotor comprising a containment vessel may include a valve for comparatively high pressures or comparatively high temperatures where sealing materials may lose strength.

FIG. 8B shows an assembly 8100 having an alternative inclusion geometry 8102. FIG. 8C shows an assembly 8200 having a circumferential channel 8202 utilizing the inclusion geometry of FIG. 8B. FIG. 8D shows an assembly 8300 having an alternative channel arrangement 8302 wherein the channel is designed to hold additional volume. FIG. 8E shows an alternative rotor 8400 comprising a surface coating of the sealing material in a region 8402. FIG. 8F shows an alternative inclusion geometry in which a compliant sealing material 8502 is sandwiched between rigid structures 8002 and 8504. Some alternative embodiments may eliminate 8504. FIG. 8G shows an alternative geometry wherein a microfluidic circuit 8602 having a plurality of ports 8604 may be sandwiched between rigid structures. Some alternative embodiments may eliminate element 8504. Some such embodiments may comprise a general microfluidic network 8602 having a port 8604 that aligns with at least one port in a valve body.

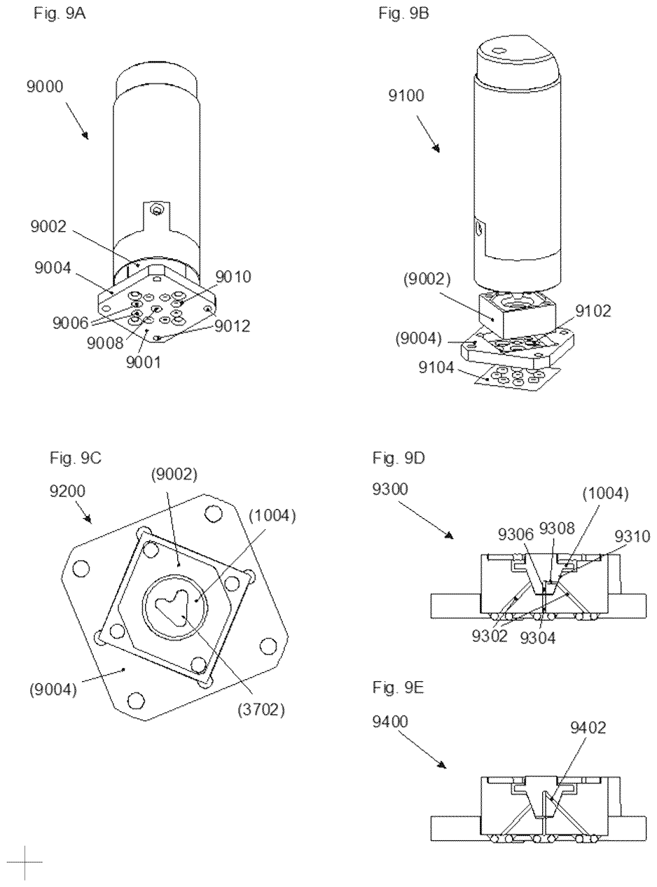

FIG. 9 shows exterior and interior views of a valve embodiment that may be suitable for mounting on a microfluidic manifold (not shown), comprising an assembly of ports channels and mounting points as known in the art. FIG. 9A shows a tilted exterior view 9000 showing the surface 9001 that interfaces to the manifold. This embodiment comprises a valve body 9002 and valve base 9004 that are designed to direct channels toward 9001. Elements 9006 are a plurality of ports disposed substantially radially around the rotation axis. Element 9008 is a port disposed on the rotation axis. Element 9010 is a sealing embodiment, such as an o-ring, a crush ring, a gasket, an adhesive bead, etc., as known in the art. Element 9012 is a mounting hole whereby a mechanical faster may maintain a mechanical preload to resist pressure and prevent leaks. This represents one of many preload mechanism embodiments, such as clips, clamps, threads, broken threads, etc. as known in the art. The best preload mechanism may be defined by end-use requirements. For example, if the valve is to be used with a disposable manifold, this and other linkages may be designed to be conveniently made released via actuating a lever. Some embodiments, may incorporate element 9004 into a manifold. Some embodiments may further incorporate element 9002 into the manifold. Some embodiments may package the rotor 1004 with the manifold. An advantage of such embodiments may be the ability to discard and replace the wetted components of an assembly.

FIG. 9B shows an exploded view 9100 revealing features 9102 in the base plate (9004) to accommodate, implement, or enhance sealing, assembly, and alignment. Element 9104 is an alternate-geometry base seal, such as a cast gasket, ganged o-rings, crush rings, etc.

FIG. 9C shows a top view 9200 of the manifold interface showing an embodiments of rotor head 1004 having coupling feature 3702.

FIG. 9D shows a cut-away cross-section view 9300 of the horizontal midplane of 9200. Elements 9302 are channels disposed along straight conical rays that would intersect at the rotation axis. These channels lead to ports 9006. Element 9304 is a channel disposed along the rotation axis, leading to port 9008. Element 9306 is a channel in the rotor that leads to 9304. Element 9308 intersects with 9036 to form an “L” channel. In some preferred embodiments, this channel is designed such that it meets a conically disposed channel (9302) at substantially the same angle relative to the rotor taper 9310, so the foreshortened holes have substantially the same elliptical shape. FIG. 9E shows a cutaway view 9400 of an alternative channel arrangement 9402 that satisfies the “equal-angle” criterion.

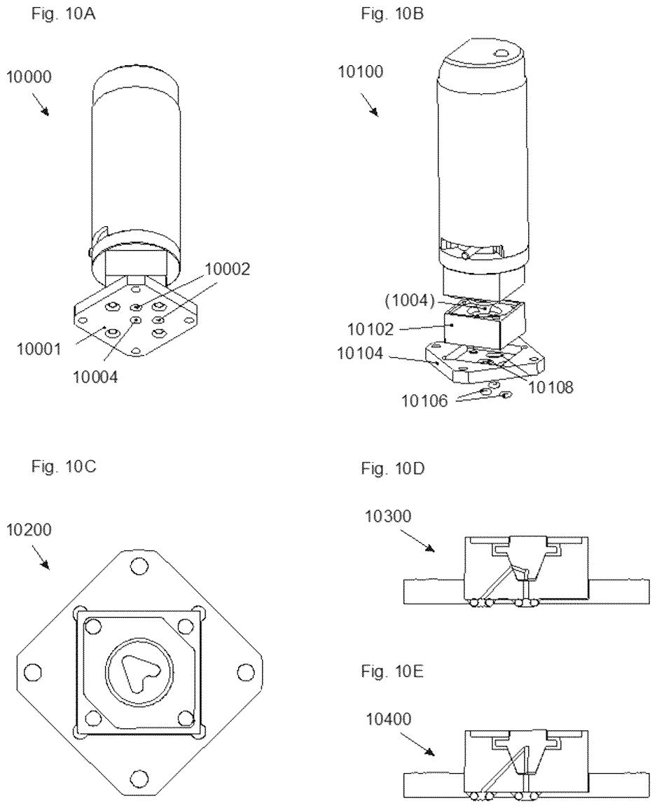

FIG. 10 show views of a three-port valve that is designed to support manifold mounting, similar to that shown in FIG. 8. FIG. 10A shows a tilted external view 10000, revealing the mating surface 10001 that comprises ports to a pair of channels 10002 that are conically arrayed about the rotation axis, and a port to a channel along the rotation axis 10004. FIG. 10B shows an exploded view 10100 of the rotor (1004), valve body embodiment 10102 and base plate embodiment 10104 that implement the conical channel arrangement. In some embodiments, seals may be made via external seals such as o-rings 10106. Some embodiments of base plates provide features 10108 that support an external seal. Some embodiments of base plates incorporate features 10108 that effect seals, such as embosses, rings, ridges, conicals, and mesas where a preload force may be locally amplified. In some embodiments 10108 is a layer or lamination on the base 10104. In some embodiments, the layer may be a patterned electroplated, press-fit, or otherwise captive soft metal or adhered, press-fit captive polymer.

FIG. 10C shows a top-view 10200 of the rotor (1004), body (10002) and base plate (10004). FIG. 10D shows a cut-away view 10300 along the horizontal mid plane of the view 10200. This view reveals the conical channel 10302 geometry to the port 10002 and the rotary-axis-aligned channel 10304 to port 10004. The intersecting channels 10306 and 10308 comprise an “L” channel through the rotor head, wherein channel 10308 is oriented to satisfy the ellipse-matching angle as described earlier. In some embodiments, it may be preferred for practical purposes to choose a non-optimal orientation of 10308. For most applications an error of +/−30° has little effect on performance. FIG. 10E shows a similar view wherein the second rotor channel follows the second ellipse-matching angle.

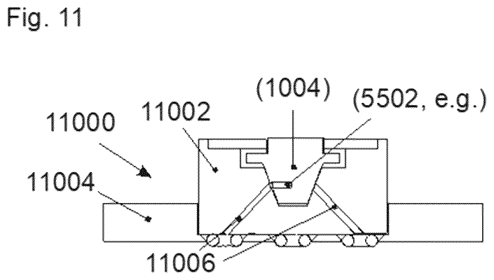

With similar context to FIG. 10D, FIG. 11 shows a cut-away view 11000 of the rotor (1004), body 11002 and base plate 11004 in a circumferential channel valve designed for manifold mounting. Elements 11006 are conically disposed channels about the rotational axis. In this embodiment, the rotor contains a circumferential channel, e.g., 5502. As with the previously discussed embodiment, this channel is disposed to intersect with zero, one, or more ports, depending on the rotational angle of the rotor.

Some embodiments of valves may employ the swept volume inside the rotor in a metered dosing capacity, in which the rotor volume is filled in one valve position, then emptied as a sample plug of well-controlled volume into another channel. Some embodiments of valve rotors may comprise a channel geometry having an additional volume beyond that needed for connecting valve body ports, herein called “storage volume,” e.g., element 5302.

What is claimed is:

1. A microfluidic valve comprising:
an axis;
a tapered rotor having a taper along the axis and a valve body having a substantially complementary rotor cavity wherein the rotor resides;
a container for the valve body that substantially surrounds the valve body on all sides except the side opposite of the rotor cavity;
a removable plate that backs the valve body;
a stem substantially aligned with the axis that applies a preload force along the axis to the proximal surface of the rotor and transfers torques around the axis from an actuator;
at least one port in the valve body that is aligned with a port in the container; and
at least one opening in the rotor such that in at least one angular position of the rotor and valve body, the opening substantially aligns with the port.

2. The microfluidic valve of claim 1 further comprising a hole in the base of the valve body substantially centered on the axis.

3. The microfluidic valve of claim 1 further comprising a threaded hole through the valve body such that an object threaded into the hole can exert a force on the container to push the valve body from the cavity.

4. The microfluidic valve of claim 1 further comprising a stack of a threaded ring, a spring washer and a thrust bearing that bears on a surface of the stem distal to the rotor, all substantially aligned with the axis.

5. The microfluidic valve of claim 1 further comprising a crossbar connected normal to the valve stem and disposed to contact a stationary surface when a port of the valve body aligns with a port in the rotor.

6. The microfluidic valve of claim 5 further comprising a valve body having 3-ports and a rotor containing an “L” channel.

7. The microfluidic valve of claim 6 further comprising a valve body having a plurality of ports disposed in a conical array and a port along the rotation axis and a valve rotor having an “L” channel wherein a channel coincident to the rotation axis intersects with a second channel that is disposed to overlap at least one of the conically-arrayed ports.

8. The microfluidic valve of claim 5 further comprising a valve body having a plurality of ports and a rotor containing one or more circumferential channels.

9. The microfluidic valve of claim 8 further comprising a conically disposed flow channel in the valve body that intersects with a circumferential rotor channel in a range of rotation angles.

10. A microfluidic rotary valve comprising:
a ratcheting positioner comprising a shaft that rotates around an axis;
a crossbar attached normal to the shaft;
a spring;
a stationary structure; and
a ratchet ring centered on the axis having a plurality of radially disposed ramping ridges that are terminated by a step, the ramps disposed to engage periodically with the crossbar when the shaft rotates, the stationary structure blocking rotation of the ratchet about the axis, the spring disposed between the stationary structure and ratchet ring such that rotation of the cross bar presses the ratchet ring against the spring as the crossbar traverses a ridge and releases the ring after passing the ridge in one rotational direction and the ridge step blocks backward rotation.

11. The microfluidic rotary valve of claim 10 wherein the ratchet ring further comprises a partial ridge that engages with an asymmetrically disposed crossbar once per rotation.

12. The microfluidic valve of claim 10 further comprising a valve body having plurality of ports disposed in the rotation plane and a port comprising a channel disposed along the rotation axis and an intersecting channel, and a rotor having an “L” channel wherein a channel coincident to the rotation axis and a channel disposed along the rotation plane intersect.

13. The microfluidic valve of claim 10 further comprising a valve body comprising a plurality of ports disposed along the rotation plane and a rotor comprising one or more circumferential channels disposed along the rotation plane.

14. The microfluidic valve of claim 10 further comprising a valve body having a plurality of ports disposed in a conical array and a port along the rotation axis and a valve rotor having an “L” channel wherein a channel coincident to the rotation axis intersects with a second channel that is disposed to overlap at least one of the conically-arrayed ports.
